(19) United States
(12) Patent Application Publication
(10) Pub. No.: US 2017/0015245 A1
(43) Pub. Date: Jan. 19, 2017

(54) VEHICLE WARNING SYSTEM AND METHOD OF SAME

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 14/812,814

(22) Filed: Jul. 29, 2015

(30) Foreign Application Priority Data
Jul. 16, 2015 (CN) 201510417842.1

(51) Int. Cl. B60R 1/00

(52) U.S. Cl. CPC B60R 1/00; B60R 2300/102; B60R 2300/107; B60R 2300/8033

(57) ABSTRACT

A vehicle warning system includes a device containing camera, a determining unit coupled to the camera, and an executing unit coupled to the determining unit. The camera is located on the device on a vehicle and obtains images of a scene including depth perception. The determining unit compares data of a current 3D image with characteristic data of a 3D surroundings module and determines whether pedestrians appear in the current 3D image. The executing unit turns on an alarm system of the vehicle device when pedestrian is within a certain distance of the vehicle and obstructs the vehicle. The disclosure further offers a vehicle warning method.

### FIELD

The subject matter herein generally relates to vehicle warning systems, and particularly, to a vehicle warning system capable of automatically turning on an alarm system of a vehicle and a related method.

### BACKGROUND

A driver can determine to turn on lights of a vehicle according to visibility. The light emitted by the lights not only increases the visibility of the driver, but also makes the vehicle more easily seen by others, such as the drivers of other vehicles or pedestrians. In addition, a loudspeaker can be turned on as an audible indicator for pedestrians, or to warn when the distance between the vehicle and obstacles or pedestrians is less than a safe distance.

### BRIEF DESCRIPTION OF THE DRAWINGS

Implementations of the present technology will now be described, by way of example only, with reference to the attached figures.

FIG. 1 is a diagrammatic view of an example embodiment of a vehicle warning system.

FIG. 2 is a block diagram of an example embodiment of the vehicle warning system of FIG. 1.

FIG. 3 is a diagrammatic view of a 3D surroundings model of the vehicle warning system being created in a first angle.

FIG. 4 is a diagrammatic view of the 3D surroundings model of the vehicle warning system being created in a second angle.

FIG. 5 is a diagrammatic view of a current 3D surroundings image of vehicle warning system of FIG. 2 to which X-Y coordinates are applied.

FIG. 6 is a diagrammatic view of the current 3D surroundings image of vehicle warning system of FIG. 2 to which Z-coordinates are applied.

FIG. 7 is a diagrammatic view of a vehicle device of the vehicle warning system of FIG. 1 in an unobstructed location.

FIG. 8 is a diagrammatic view of the vehicle device of the vehicle warning system of FIG. 1 in an obstructed location.

FIG. 9 is a diagrammatic view of the vehicle device of the vehicle warning system of FIG. 1 in an obstructed location and the lights of the vehicle device are turned on.

FIG. 10 is a diagrammatic view of the vehicle device of the vehicle warning system of FIG. 1 in an obstructed location and the lights and the loudspeaker of the vehicle device are turned on.

FIG. 11 is a flowchart of a vehicle warning method using the vehicle warning system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a vehicle warning system. The vehicle warning system includes a camera, a determining unit coupled to the camera, and an executing unit coupled to the determining unit. The camera is located in a device on a vehicle to obtain an image of a scene around the vehicle including perception of depth in relation to objects appearing in the scene (current 3D surroundings image). The determining unit compares data of the current 3D surroundings image with a characteristic data of a 3D surroundings module and determines whether any pedestrians appear in the current 3D surroundings image. The executing unit turns on an alarm system of the vehicle device when pedestrians are apparent in the current 3D surroundings image.

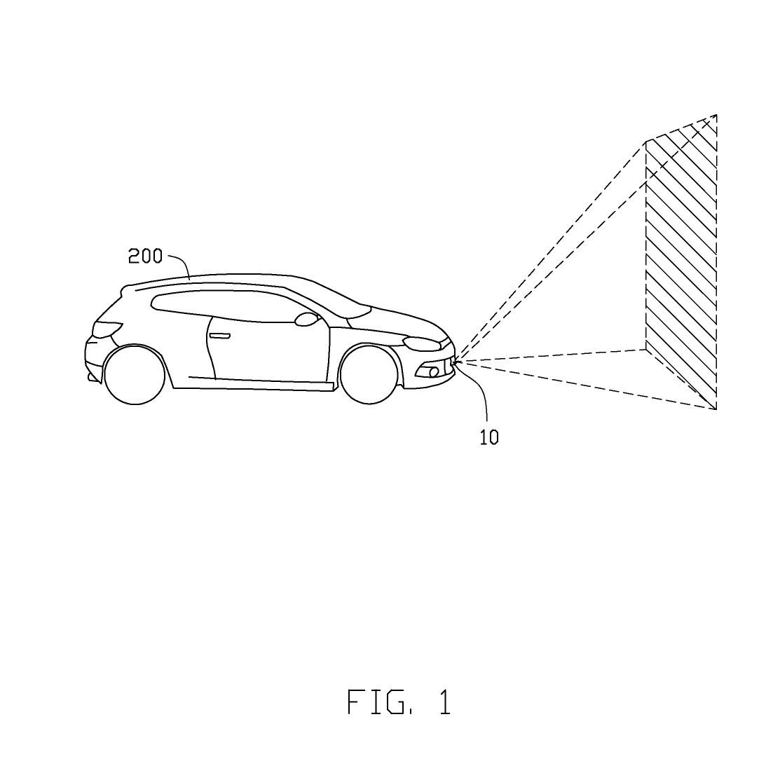

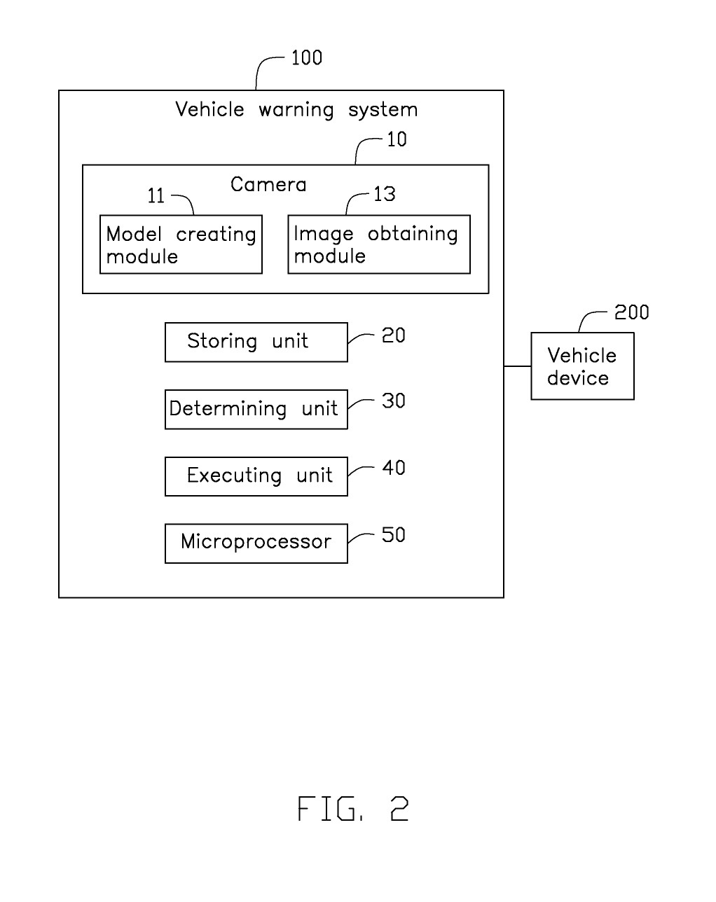

FIGS. 1-2 illustrate an embodiment of a vehicle warning system 100 configured to be used in a vehicle device 200. The vehicle warning device 100 can include a camera 10, a storing unit 20, a determining unit 30, an executing unit 40, and at least one microprocessor 50. In at least one embodiment, the vehicle warning system 100 comprises computerized instructions in the form of one or more computer-readable programs stored in the storing unit 20 and executed by the at least one microprocessor 50. The vehicle carrying the vehicle device 200 can be a car, a bus, a taxi, a truck, or the like. FIG. 1 is only one example of the vehicle device 200, other examples may comprise more or fewer components than those shown in the embodiment, or have a different configuration of the various components.

The camera 10 can be arranged on the front of the vehicle device 200 and can capture images of the surroundings (surroundings images) of the vehicle. Images of the scene in front of the vehicle device 200 can be captured. Each captured surroundings image includes distance information indicating the distance between the camera 10 and each object in the field of view of the camera 10. In the embodiment, the camera 10 is a 3D image capturing device, such as a depth-sensing camera or a Time of Flight (TOF) camera. The surroundings image captured by the camera 10 can be used to control vehicle lights. For example, in FIG. 1, the surroundings image of the spatial scene within dotted lines can be used to control the lights which illuminate the spatial scene. In addition, the surroundings image captured by the camera 10 enclosed by broken line can be used to control the lights circled by broken line to be turned on or off.

The camera 10 can include a model creating module 11 and an image obtaining module 13. The model creating module 11 is configured to create a 3D surroundings model based on images captured by the camera 10 and the distances between the camera 10 and each object which is apparent in the obtained surroundings image. In at least one embodiment, the 3D surroundings model can include a 3D special person module and a 3D special face module, and the 3D special person module and the 3D special face module can be stored in the storing unit 20.

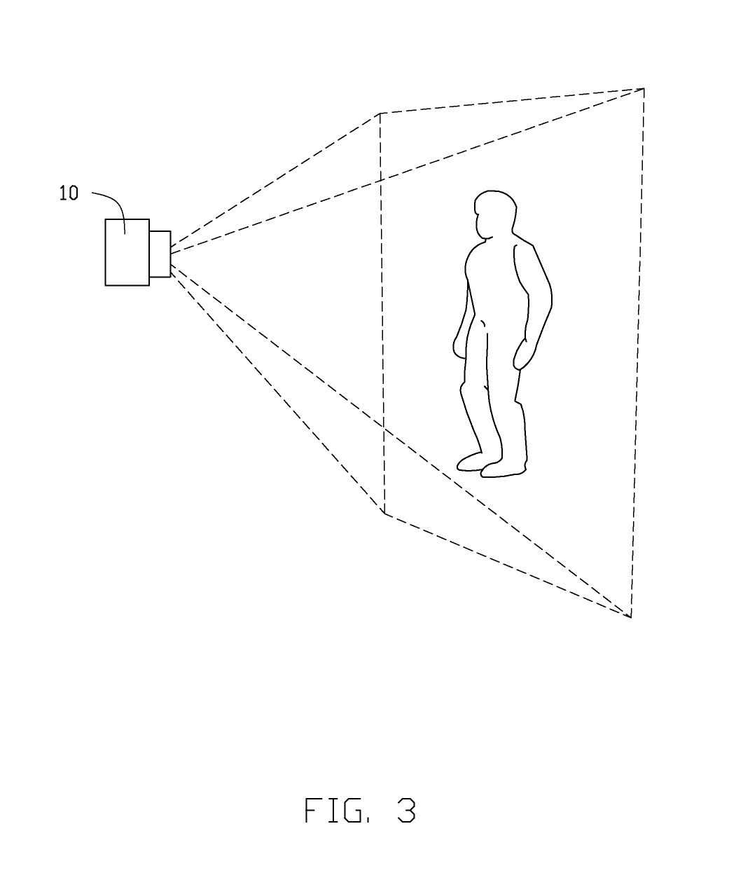

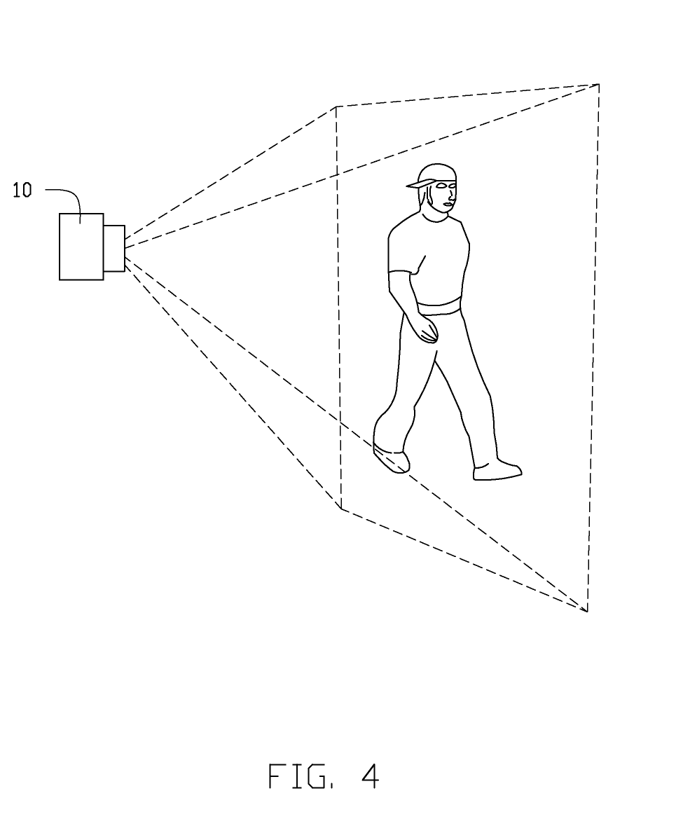

FIGS. 3-4 show the creation of the 3D surroundings model. The method of creating the 3D surroundings model can include following steps: (a) using the camera 10 to capture 3D surrounding images where a pedestrian is apparent, obtaining distances between the camera 10 and the pedestrian from each surrounding 3D image, and classifying the facial aspect of a person according to direction to which a face is pointing. A pedestrian can become “apparent” within a distance from the vehicle of 80 meters, and the face directions can include frontal to the vehicle, a side face and turned away from the vehicle; (b) storing all the distances into a character array; (c) ranking all the distances in the character array according to an ascending order; (d) calculating a position tolerance range of the pedestrian according to the ranked distances; and (e) creating the 3D surroundings models of the pedestrian according to the position tolerance and storing the 3D surroundings models into the storage unit 20.

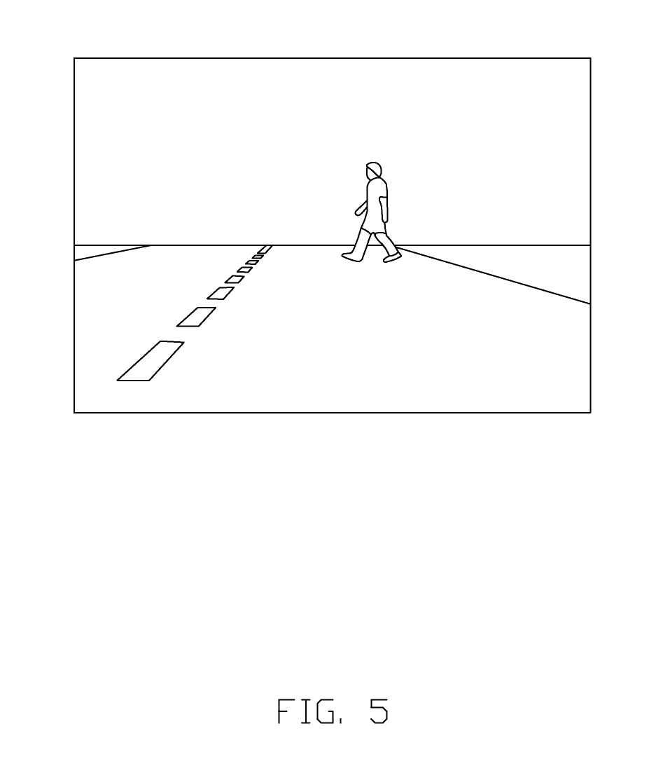

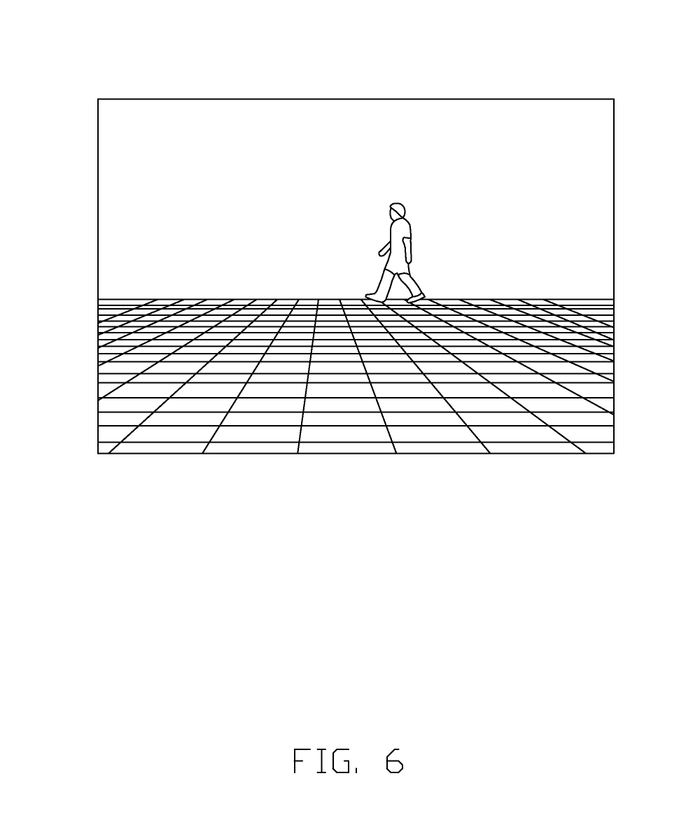

The image obtaining module 13 is configured to obtain a current 3D surroundings image captured by the camera 10. The current 3D surroundings image can include an X-Y coordinates image (see FIG. 5) and a Z-coordinates image (see FIG. 6). When a current 3D surroundings image is obtained by the image obtaining module 13, the image obtaining module 13 is configured to send the current 3D surroundings image to the determining unit 30.

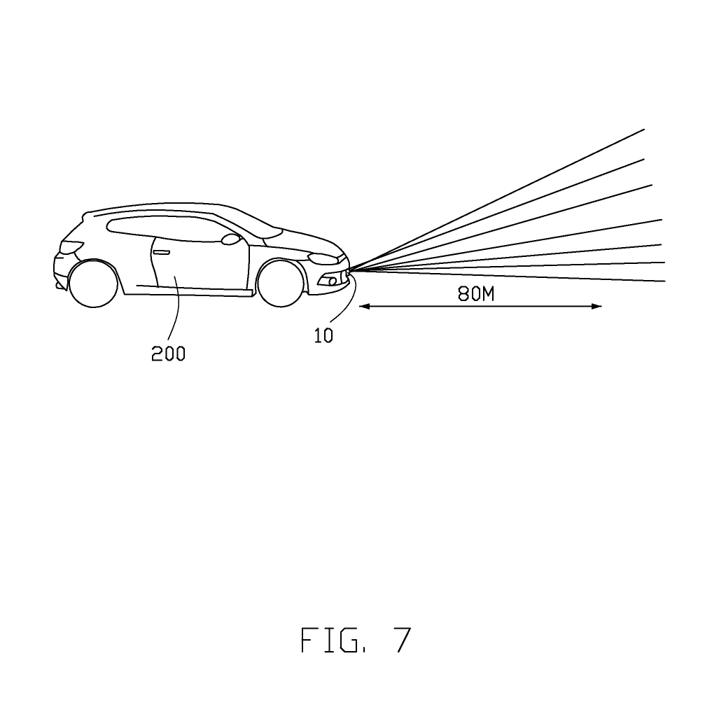

The determining unit 30 is configured to receive the current 3D surroundings image and determine the appearance of a pedestrian according to the current 3D surroundings model. For example, FIG. 7 illustrates that no pedestrian is apparent, and the vehicle carrying the vehicle device 200 is unobstructed.

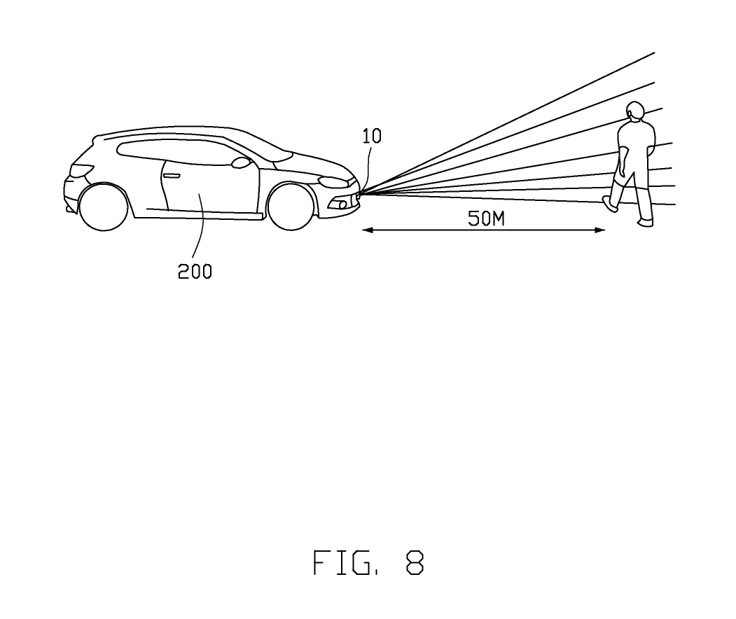

FIG. 8 illustrates the appearance of a pedestrian within a distance of 80 meters, and the vehicle is thus obstructed. Simultaneously, the determining unit 30 is configured to demarcate the location of the pedestrian in the current 3D surroundings image and compare the current 3D surroundings image with the 3D surroundings module in the storing unit 20. The comparing method of the current 3D surroundings image and the 3D surroundings module can include follow steps: (a) using the camera 10 to capture the current 3D surrounding images, obtaining a distance between the camera 10 and the pedestrian from the current surrounding 3D image; the current 3D surrounding images can include a current 3D person image and a current 3D face image; (b) storing all the distances into a current character array; (c) comparing the current 3D surrounding image with the 3D surroundings module; if the extracted data of the current 3D surrounding image does not match the characteristic data of any of the 3D surroundings modules, the vehicle device 200 is unobstructed. If the extracted data of the current 3D surrounding image matches the characteristic data of any of the 3D surroundings modules, the vehicle can be said to be obstructed. In addition, a result of comparison, including the face direction and location of a pedestrian, can be sent to the executing unit 40 by the determining unit 30.

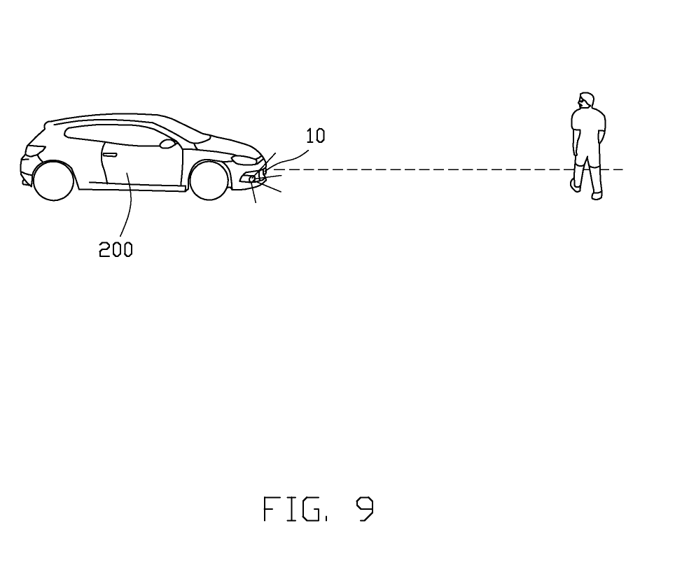

FIG. 9 illustrates the lights being turned on by the executing unit 40. When a pedestrian is apparent (within a distance of 80 meters) and the face direction is frontal to the vehicle device 200, the executing unit 40 is configured to turn on the lights of the vehicle device 200 and apply flicker to the lights, as a warning.

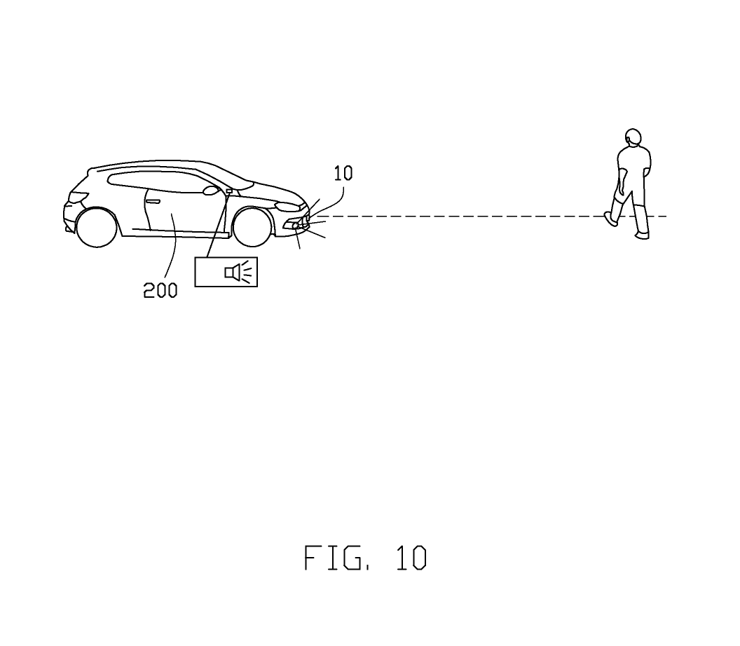

FIG. 10 illustrates the alarm system, such as lights and speakers, of the vehicle device 200 being turned on by the executing unit 40. When a pedestrian is apparent and the face direction is a side face, or turned away from the vehicle, the executing unit 40 is configured to turn on the lights and the speaker of the vehicle device 200 and apply flicker to the lights, providing audible as well as visiblewarnings.

In general, the word “module”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

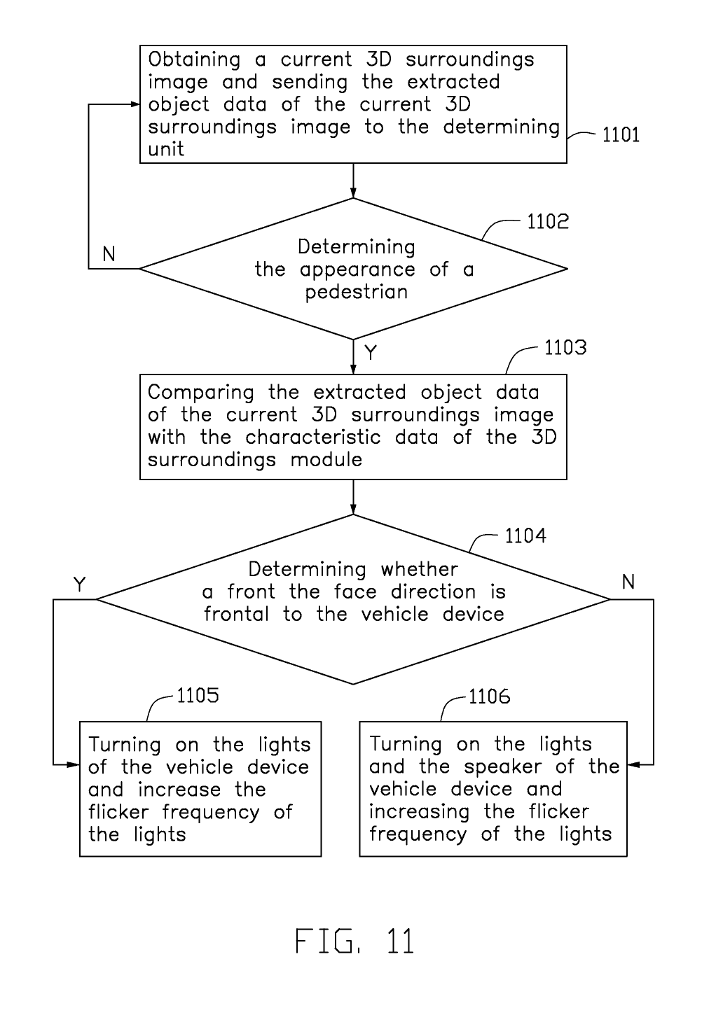

Referring to FIG. 11, a flowchart is presented in accordance with an example embodiment which is being thus illustrated. The example method 110 is provided by way of example, as there are a variety of ways to carry out the method. The method 110 described below can be carried out using the configurations illustrated in FIGS. 1-10, for example, and various elements of these figures are referenced in explaining example method 110. Each block shown in FIG. 110 represents one or more processes, methods, or subroutines, carried out in the exemplary method 110. Additionally, the illustrated order of blocks is by example only and the order of the blocks can change. The exemplary method 110 can begin at block 1101.

At block 1101, the image obtaining module 13 obtains an image of a scene around the vehicle including perception of depth in relation to objects appearing in the scene (current 3D surroundings image) captured by the camera 10 and send the extracted object data of the current 3D surroundings image to the determining unit 30. The current 3D surroundings image can include an X-Y coordinates image (see FIG. 5) and a Z-coordinates image (see FIG. 6).

At block 1102, the determining unit 30 receives the extracted object data of the current 3D surroundings image and determines the appearance of a pedestrian. If yes, goes on block 1103, and if not, goes back block 1101.

At block 1103, the determining unit 30 demarcate the location of the pedestrians in the current 3D surroundings image and compare the extracted object data of the current 3D surroundings image with the characteristic data of the 3D surroundings module in the storing unit 20.

At block 1104, the determining unit 30 determines the face directions in the current 3D surroundings image to send to the executing unit 30 and further determines whether the face direction is frontal to the vehicle device 200, if yes, goes on block 1105, if no, goes on block 1106.

At block 1105, the executing unit 40 turns on the lights of the vehicle device 200 and increase the flicker frequency of the lights as a warning.

At block 1106, the executing unit 40 turns on the lights and the speaker of the vehicle device 200 and increase the flicker frequency of the light as a warning.

The embodiments shown and described above are only examples. Many details are often found in the art such as the other features of a vehicle warning system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vehicle warning system comprising:
a camera located on a vehicle device, the camera configured to obtain an image of a scene around the vehicle including perception of depth in relation to objects appearing in the scene (current 3D surroundings image);
a determining unit coupled to the camera and is configured to compare an extracted object data of the current 3D surroundings image with a characteristic data of the 3D surroundings module; and
an executing unit coupled to the determining unit;
wherein the determining unit is configured to determine whether the pedestrians appear in the current 3D surroundings image, and the executing unit is configured to turn on an alarm system of the vehicle device when the pedestrians appear in the current 3D surroundings image.

2. The vehicle warning system of claim 1, further comprising a storing unit, wherein the 3D surroundings model comprises a 3D special person models and a 3D special face modules, and the 3D special person models and the 3D special face modules can be stored in the storing unit.

3. The vehicle warning system of claim 2, further comprising at least one microprocessor, wherein the vehicle warning system comprises computerized instructions in the form of one or more computer-readable programs stored in the storing unit and executed by the at least one microprocessor.

4. The vehicle warning system of claim 2, wherein the determining unit is further configured to determine the face directions in the current 3D surroundings image according to the 3D special face modules, and the executing unit is configured to turn on the alarm system of the vehicle device according to the face directions.

5. The vehicle warning system of claim 4, wherein the alarm system comprises a light and a speaker, the executing unit is configured to turn on the light when the face direction is a front face, and the executing unit is configured to turn on the speaker and the light when the face directions are a back face and a side face.

6. The vehicle warning system of claim 1, wherein the camera comprises a model creating module, the model creating module is configured to create the 3D surroundings model corresponding to the camera according to the obtained surroundings image captured by the camera and a safe distance between the corresponding camera and each object recorded in the obtained surroundings image.

7. The vehicle warning system of claim 6, wherein the camera further comprises an image obtaining module, and the current 3D surroundings image is obtained by the image obtaining module.

8. The vehicle warning system of claim 1, wherein the camera is a depth-sensing camera

9. The vehicle warning system of claim 1, wherein the vehicle device is a car, a bus, a taxi, or a truck.

10. A vehicle warning method comprising:
(a) obtaining an image of a scene around the vehicle including perception of depth in relation to objects appearing in the scene (current 3D surroundings image) by a camera located on a vehicle device,
(b) comparing an extracted object data of the current 3D surroundings image with a with a characteristic data of the 3D surroundings module of a 3D surroundings module by a determining unit;
(c) determining whether the pedestrians appear in the current 3D surroundings image by the determining unit; and
(d) turning on an alarm system of the vehicle device when the pedestrians appear in the current 3D surroundings image by an executing unit.

11. The vehicle warning method of claim 10, the 3D surroundings model comprises a 3D special person models and a 3D special face modules wherein before the step (a) comprises following step: storing the 3D special person models and the 3D special face modules in a storing unit.

12. The vehicle warning method of claim 11, wherein the step (b) comprises following step: determining the face directions in the current 3D surroundings image according to the 3D special face modules by the determining unit, and the step (d) comprises following step:
turning on the alarm system of the vehicle device according to the face directions by the executing uni.

13. The vehicle warning method of claim 12, the alarm system comprises a light and a speaker, wherein the step (d) comprises following step: turning on the light by the executing unit when the face direction is a front face, or turning on the speaker and the light by the executing unit when the face directions are a back face and a side face.

14. The vehicle warning method of claim 10, wherein before the step (a) further comprises following step: creating the 3D surroundings model corresponding to the camera according to the obtained surroundings image captured by the camera and a safe distance between the corresponding camera and each object recorded in the obtained surroundings image by a model creating module.

15. The vehicle warning method of claim 10, wherein the camera is a depth-sensing camera.

16. The vehicle warning method of claim 10, wherein the vehicle device is a car, a bus, a taxi, or a truck.
